(19) United States
(12) Patent Application Publication
(10) Pub. No.: US 2020/0210367 A1
(43) Pub. Date: Jul. 2, 2020

(54) EXTERNAL SERIAL AT ATTACHMENT DEVICE

(71) Applicant: HEWLETT-PACKARD DEVELOPMENT COMPANY, L.P., Spring, TX (US)

(72) Inventors: Monji G. Jabori, Houston, TX (US); Jonathan Vu, Houston, TX (US)

(21) Appl. No.: 16/481,082

(22) PCT Filed: Sep. 6, 2017
(86) PCT No.: PCT/US2017/050272

§ 371 Date: Jul. 26, 2019

(51) Int. Cl. G06F 13/42; G06F 13/16; G11B 33/04

(52) U.S. Cl. CPC G06F 13/4282; G06F 2213/0032; G11B 33/0472; G06F 13/1668

(57) ABSTRACT

A system may include a computing device. The computing device may include an optical disc drive (ODD) bay, wherein an ODD is not present in the ODD bay. The system may further include an ODD connector. The system may also include an external serial AT attachment (eSATA) device located in an opening of the ODD bay for housing the non-present ODD and coupled to the computing device by the ODD connector at the ODD bay.

### BACKGROUND

External serial AT attachment (eSATA) devices may be used and added to computing systems. eSATA is a computer bus interface that connects host bus adapters to mass storage devices such as hard disk drives, optical drives, and solid-state drives. eSATA connectors can be specified for external devices.

### BRIEF DESCRIPTION OF THE DRAWINGS

FIG. 1 is an example system for an external serial AT attachment (eSATA) device consistent with the present disclosure.

FIG. 2 is another example system for an eSATA device consistent with the present disclosure

FIG. 3 is another example system for an eSATA device consistent with the present disclosure.

FIG. 4 is an example method for an eSATA device consistent with the present disclosure.

### DETAILED DESCRIPTION

Computing devices, such as laptop computers, desktop computers, and the like, may include an optical disc drive (ODD). As used herein, an ODD refers to a disc drive that uses laser light or electromagnetic waves to read and/or write data to and/or from an optical disc, ODDs may be found in Compact Disc (CD) drives, Digital Versatile Disc (DVD) drives, and other drives using optical discs. ODDs may be used in computing devices to play CDs or DVDs, but may also be used to read software contained on optical discs and to back up data onto an optical disc. A device using an ODD may poll the ODD at a regular interval of time to determine if the ODD had media in it. If media was present in the ODD, the device may continue to provide power to the ODD; if no media was present, the device may cut power to the ODD until the next polling interval.

One type of ODD is a Zero Power optical disc drive (ZPODD). In a system that uses a ZPODD, power may be provided to the ODD when there is media, such as an optical disc, in the drive, and may not be provided to the ODD when no media is present. In a ZPODD, the device may not poll the ODD at regular intervals to determine whether media is present. Instead, a device attention pin on an ODD connector may be used to signal whether media is present. As used herein, a pin refers to a part of a signal interface in a computing device. A pin may connect with a corresponding female connector on the computing device. A device attention pin refers to a particular pin, that is, a pin tied to device attention. As used herein, device attention refers to an amount of power provided by and/or to a device. A device attention pin, therefore, refers to a pin that signals an amount of power provided by and/or to a device. In some examples, a device attention pin may signal a numerical amount of power. In some examples, a device attention pin may signal power as “high” (e.g., above a particular threshold amount of power, such as 3 Volts, although examples are not so limited) or “low” (e.g., below a particular threshold of power, such as 3 Volts, although examples are not so limited).

However, a user of a computing device may desire to replace the ODD with a different device, such as an External Serial AT Attachment (eSATA) device. In some examples, a user of a computing system may desire to use an existing port on the computing device, such as an Optical Disc Drive (ODD) port, to power the eSATA device. eSATA devices may thus be used in lieu of ODDs in computing systems.

For an eSATA device to work, a particular amount of power must be provided to the eSATA device via a SATA interface. However, an eSATA device may not be recognized as media if the eSATA device is connected to the computing device using an ODD connector, particularly if the ODD connector is a ZPODD connector. As a result, the device attention pin on the ODD connector may not assert correctly, resulting in no power being transmitted by the computing device to the eSATA device.

An eSATA device according to the present disclosure may allow an eSATA device to use a ZPODD connector, particularly when an ODD is no longer present in the system. In some examples, an eSATA device according to the present disclosure may include determining that an eSATA device is coupled to the computing device by an ODD connector. In response, a device attention pin on the ODD connector may assert ‘low’, such that power may be provided to the eSATA. As used herein, to assert low refers to the device attention pin having its power level pulled down, as will be discussed further herein. This may allow the eSATA device to receive power from the ODD connector, even though no media is present.

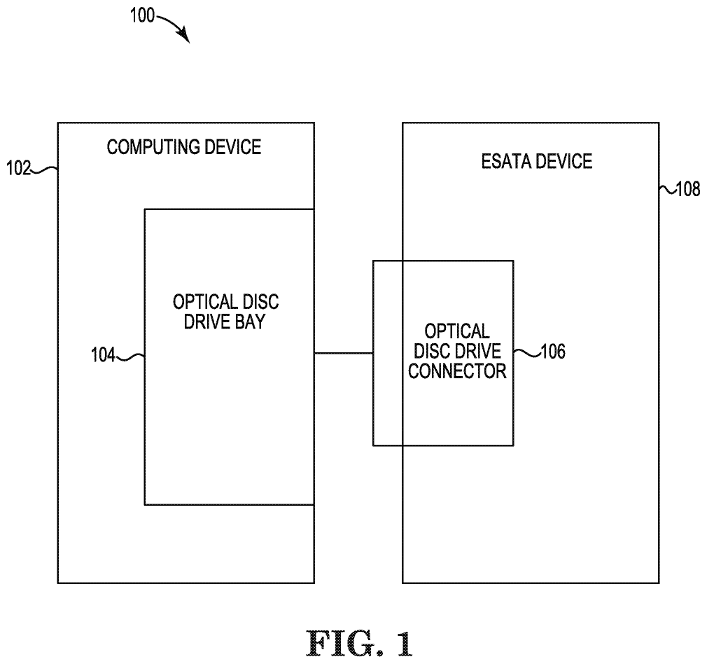

FIG. 1 is an example system 100 for an eSATA device consistent with the present disclosure, System 100 may include a computing device 102. As used herein, a computing device refers to a device including a processing resource, memory, and input/output interfaces for wired and/or wireless communication. For example, a client device may include a laptop computer, a desktop computer, a mobile device, and/or other wireless devices, although examples of the disclosure are not limited to such devices.

Computing device 102 may include an optical disc drive (ODD) bay 104. As used herein, an ODD bay refers to a part of a computing device, such as computing device 102, designed to receive an ODD. For example, an ODD bay 104 may be a cutout designed to receive an ODD, although examples are not so limited. As shown in system 100, ODD bay 104 may be integrated with computing device 102.

In some examples, ODD bay 104 may be configured for a ZPODD. As described previously, ZPODD refers to a system in which power may be provided to the ODD when there is media, such as an optical disc, in the drive, and may not be provided to the ODD when no media is present. Moreover, an ODD may not be present in ODD bay 104. That is, ODD bay 104 may lack a corresponding ODD. In such examples, the ZPODD may not register presence of media and thus may not provide power to the ODD bay 104.

System 100 may further include an eSATA device 108. The eSATA device 108 may be coupled to the computing device 102 at ODD bay 104 by an ODD connector 106. The eSATA device 108 may be located in an opening of the ODD bay 104. That is, the eSATA device 108 may be located in the ODD bay 104 at an opening for housing the non-present ODD.

In some examples, ODD connector 106 may include a device attention pin (not illustrated in FIG. 1). As described previously, a device attention pin device refers to a pin that signals an amount of power provided by and/or to a device. In some examples, the device attention pin may assert low. As previously noted, to assert low refers to the device attention pin having its power level pulled down. In some examples, the power level may be pulled down by the device attention pin completing a connection to a ground. In some examples, the power level may be pulled down through the use of a resistor to reduce an amount of power to the device attention pin.

In some examples, the device attention pin may assert low in response to the eSATA device 108 being coupled to the computing device 102 by the ODD connector 106. That is, the power at the device attention pin may be pulled down when the eSATA device 108 is coupled to the computing device 102. In some examples, the power may be pulled down on the device attention pin, or asserted low, in response to the connection of the computing device 102 to the eSATA device 108 by the ODD connector 106. Said differently, the connection at the ODD connector 106 of the eSATA device 108 to the computing device 102 may cause the device attention pin to assert low.

Asserting the device attention pin low may allow power to be transmitted from the computing device 102 to the eSATA device 108. In some examples, power may be transmitted to the eSATA device 108 through the ODD connector 106. The eSATA device 108 may include a plurality of pins, which may be used to couple the eSATA device to the ODD connector 106. Moreover, the plurality of pins on the eSATA device 108 may be used to provide power to the eSATA device 108, In some examples, the plurality of pins located on the eSATA device 108 may receive power from the ODD connector 106. As described previously, the ODD connector 106 may be used to provide power to the eSATA device 108 and, thus, may provide power to the plurality of pins on the eSATA device 108, In some examples, a subset of the plurality of pins located on the eSATA device 108 may be provided power when the eSATA device 108 is coupled to the computing device 102 by the ODD connector 106,

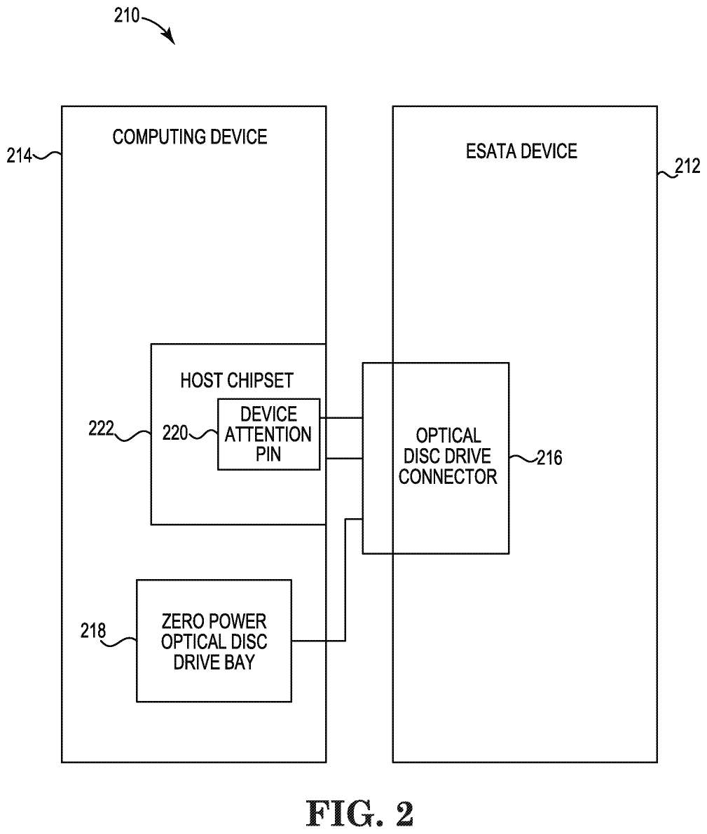

FIG. 2 is another example of a system 210 for an eSATA device consistent with the present disclosure. System 210 may include an eSATA device 212. eSATA device 212 may be akin to eSATA device 108 described with respect to FIG. 1. eSATA device 212 may be coupled to a computing device 214. Computing device 214 may be akin to computing device 102 described with respect to FIG. 1. In some examples, eSATA device 212 may be coupled to computing device 214 by an ODD connector 216. ODD connector 216 may be akin to ODD connector 106 discussed with respect to FIG. 1.

eSATA device 212 may be coupled to a ZPODD bay 218, In some examples, ZPODD bay 218 may be contained within the computing device 218. As described previously, ZPODD bay 218 may correspond to a particular type of ODD bay. In some examples, ZPODD bay 218 may correspond to an ODD bay, such as ODD bay 104, described with respect to FIG. 1. eSATA device 212 may be coupled to ZPODD bay 218 by ODD connector 216,

System 210 may further include a device attention pin 220. Device attention pin 220 may be located within computing device 210, although examples are not so limited. Moreover, device attention pin 220 may be coupled to ODD connector 216. As described with respect to FIG. 1, device attention pin 220 may assert low when eSATA device 212 is coupled to computing device 214. That is, device attention pin 220 may assert low in response to a determination that eSATA device 212 is coupled by ODD connector 216 to the computing device 214, In some examples, device attention pin 220 may assert low in response to being coupled to a resistor. The resistor may lower an amount of power to the device attention pin 220, Said differently, the resistor may “step down” an amount of power received by the device attention pin 220, thus causing device attention pin 220 to assert low,

Device attention pin 220 be located on a host chipset 222. As used herein, a chipset refers to a set of electronic components that are part of an integrated circuit found on a motherboard of a computing device, A chipset may be used to manage data flow between a processor, a memory, and/or accessories of the computing device in which the chipset resides. A host chipset refers to a particular chipset within a computing device that is directly connected to a processor of the computing device, such as a central processing unit (CPU), using a front-side bus (FSB). In some examples, the host chipset may be used to manage tasks that require high levels of performance.

Host chipset 222 may be coupled to ODD connector 216. In some examples, host chipset 222 may provide power to the eSATA device 212 through ODD connector 216. When device attention pin 220 asserts low, host chipset 222 may receive a signal alerting to the low assertion of device attention pin 220. In response, host chipset 222 may cause power to be transmitted to ODD connector 216. As described with respect to FIG. 1, ODD connector 216 may then provide power to eSATA device 212. In some examples, ODD connector 216 may provide power to a plurality of pins located on eSATA device 212. In other examples, the ODD connector 216 may provide power to a subset of a plurality of pins on eSATA device 212.

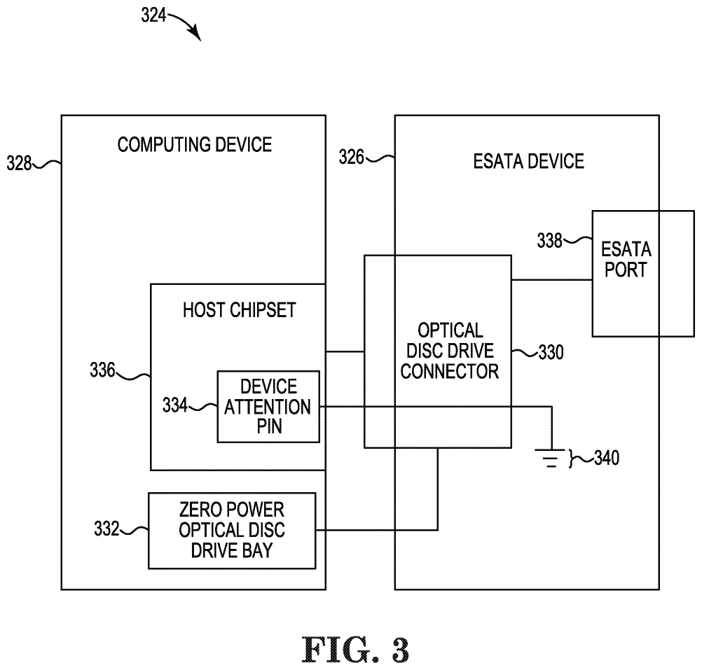

FIG. 3 is another example of a system 324 for an eSATA device consistent with the present disclosure. System 324 may include an eSATA device 326. eSATA device 326 may be akin to eSATA devices 108 and 212, discussed with respect to FIGS. 1 and 2, respectively. System 324 may further include a computing device 328. Computing device 328 may be akin to computing devices 102 and 214, discussed with respect to FIGS. 1 and 2. eSATA device 326 may be coupled to computing device 328 by an ODD connector 330. ODD connector 330 may be akin to ODD connector 106, discussed with respect to FIG. 1, and/or ODD connector 216 discussed with respect to FIG. 2.

ODD connector 330 may connect eSATA device 326 to computing device 328 at ZPODD bay 332. ODD connector 330 may further be coupled to a device attention pin 334. Device attention pin 334 may be akin to device attention pin 220, discussed with respect to FIG. 2. As described with respect to FIG. 2, device attention pin 334 may assert low when eSATA device 326 is coupled to computing device 328 by ODD connector 330. In some examples, device attention pin 334 may assert low by pulling power to a ground, such as ground 340. As used herein, ground refers to a reference point in a circuit from which voltages are measured. Pulling power to ground 340 may cause device attention pin 334 to assert low.

When device attention pin 334 asserts low, by pulling to ground 340, for example, a signal may be transmitted to host chipset 336. Host chipset 336 may be akin to host chipset 222, described with respect to FIG. 2. In response to receiving a signal that device attention pin 334 has asserted low, host chipset 336 may transmit power to the eSATA device 326, In some examples, host chipset 336 may transmit power to the eSATA device 326 through the ODD connector 330.

In some examples, ODD connector 330 may be coupled to an eSATA port 338. As used herein, an eSATA port refers to a port of an eSATA device, such as eSATA device 326. eSATA port 338 may be contained within eSATA device 326. In some examples, the host chipset 336 may provide power to the eSATA port 338, Power may be provided to the eSATA port 338 through the ODD connector 330,

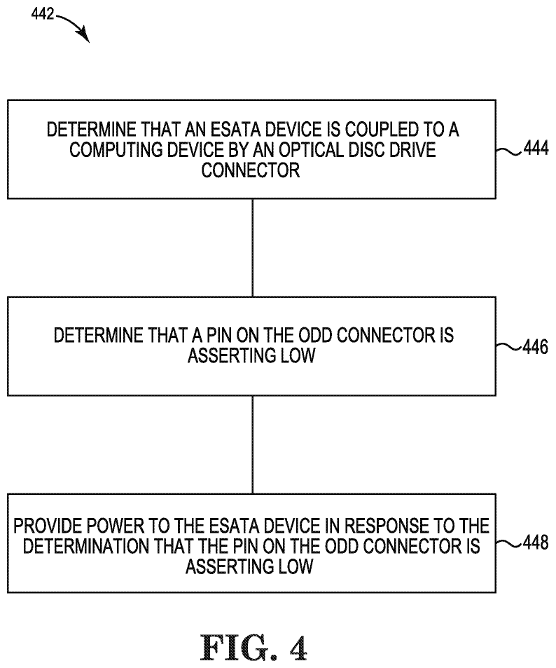

FIG. 4 is an example method 442 for an eSATA device consistent with the present disclosure. At 444, method 442 may include determining that an eSATA device is coupled to a computing device. In some examples, the eSATA device may be determined to be coupled to the computing device by an ODD connector, Determining that an eSATA device is coupled to a computing device at 444 may include determining that the eSATA device is coupled to the computing device at a ZPODD. In some examples, the eSATA device may be coupled to the computing device at the ZPODD by an ODD connector. As described with respect to FIGS. 1-3, the ZPODD may correspond to a particular ODD bay within the computing device, and an ODD may not be present in the ODD bay. Thus, the eSATA device may be coupled to the computing device at the location, such as the ZPODD, where an ODD may otherwise be located.

At 446, method 442 may include determining that a pin on the ODD connector is asserting low, As described with respect to FIGS. 2 and 3, the device attention pin may assert low by having power directed through a resistor. In some examples, determining that a pin on the ODD connector is asserting low at 446 may include determining that the pin is connected to a ground, such as ground 340, discussed with respect to FIG. 3.

At 448, method 442 may include providing power to the eSATA device in response to the determination at 446 that the pin on the ODD connector is asserting low. In some examples, power may be provided to the eSATA device by, for example, a host chipset located on the computing device to which the eSATA device is coupled. For example, power may be provided to the eSATA device at 448 by host chipset 222, discussed with respect to FIG. 2, and/or host chipset 336, discussed with respect to FIG. 3.

In some examples, providing power to the eSATA device at 448 may comprise providing power to the eSATA device by the ODD connector. That is, the ODD connector coupling the eSATA device to the computing device may provide power to eSATA device, The ODD connector may receive initial power from a different source, such as the host chipset, although examples are not so limited.

In some examples, the eSATA device may include a plurality of pins located thereon. Providing power to the eSATA device at 448 may comprise providing power to a subset of the plurality of pins of the eSATA device. That is, power may be provided to the eSATA device at 448 to a number of pins less than the full number of pins located on the eSATA device. Providing power at 448 to a subset of the plurality of pins of the eSATA device may allow the eSATA device to operate without having to provide a larger amount of power to the eSATA device.

In the foregoing detail description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of” an element and/or feature can refer to any number of such elements and/or features.

What is claimed:

1. A system, comprising:
a computing device including an optical disc drive (ODD) bay, wherein an ODD is not present in the ODD bay;
an ODD connector; and
an external serial AT attachment (eSATA) device located in an opening of the ODD bay for housing the non-present ODD and coupled to the computing device by the ODD connector at the ODD bay.

2. The system of claim 1, wherein the ODD bay is configured for a zero power optical disc drive (ZPODD).

3. The system of claim 1, wherein the ODD connector includes a device attention pin.

4. The system of claim 3, wherein the device attention pin asserts low in response to the eSATA device being coupled to the computing device by the ODD connector.

5. The system of claim 1, further comprising a plurality of pins on the eSATA device, wherein a subset of the plurality of pins is powered when the eSATA device is coupled to the computing device by the ODD connector.

6. A system, comprising:
an external serial AT attachment (eSATA) device coupled to a computing device via an optical disc drive (ODD) connector of a zero power optical disc drive (ZPODD) contained within the computing device;
a serial AT attachment (SATA) interface coupled to the eSATA device at the ODD connector;
a device attention pin coupled to the eSATA device, wherein the device attention pin asserts low when the eSATA device is coupled to the computing device; and
a host chipset coupled to the SATA interface and the ODD connector to provide power to the eSATA device.

7. The system of claim 6, wherein the device attention pin asserts low by pulling power to ground.

8. The system of claim 6, wherein the device attention pin asserts low in response to being coupled to a resistor to lower an amount of power to the device attention pin.

9. The system of claim 6, wherein the host chipset provides power to a plurality of pins on the eSATA.

10. The system of claim 6, wherein the host chipset provides power to a port on the eSATA device through the ODD connector.

11. A method, comprising:
determining that an external serial AT attachment (eSATA) device is coupled to a computing device by an optical disc drive (ODD) connector;
determining that a pin on the ODD connector is asserting low; and
providing power to the eSATA device in response to the determination that the pin on the ODD connector is asserting low.

12. The method of claim 11, wherein providing power to the eSATA device comprises providing power to the eSATA device by the ODD connector.

13. The method of claim 11, wherein determining that the eSATA device is coupled to the computing device includes determining that the eSATA device is coupled to the computing device by the ODD connector at a zero power optical disc drive (ZPODD).

14. The method of claim 11, wherein determining that a pin on the ODD connector is asserting low includes determining that the pin is connected to a ground.

15. The method of claim 11, wherein providing power to the eSATA device comprises providing power to a subset of a plurality of pins on the eSATA device.
